(19) United States
(12) Patent Application Publication
(10) Pub. No.: US 2024/0430782 A1
(43) Pub. Date: Dec. 26, 2024

(54) METHODS AND SYSTEMS FOR SUPPORTING MULTIPLE TRACKING AREA CODES IN A SATELLITE CELL

(71) Applicant: Apple Inc., Cupertino, CA (US)

(72) Inventors: Robert ZAUS, Munich (DE); Roland GRUBER, Sauerlach (DE)

(21) Appl. No.: 18/707,031

(22) PCT Filed: Nov. 2, 2022
(86) PCT No.: PCT/US2022/048699

§ 371 Date: May 2, 2024

Related U.S. Application Data
(60) Provisional application No. 63/275,268, filed on Nov. 3, 2021.

(51) Int. Cl. H04W 48/10; H04W 64/00; H04W 84/04

(52) U.S. Cl. CPC H04W 48/10; H04W 64/003; H04W 84/042

(57) ABSTRACT

Disclosed are methods, systems, and computer-readable medium to perform operations including: receiving a request message from a user equipment (UE) served by a non-terrestrial access node, where the non-terrestrial access node is broadcasting a plurality of tracking area codes (TACs), and where a first TAC is associated with a first tracking area (TA) that is forbidden for the UE; and sending, to a core network node, the plurality of TACs in at least one information element.

### CROSS-REFERENCE TO RELATED APPLICATIONS

The present application claims priority to U.S. Prov. App. No. 63/275,268, filed on Nov. 3, 2021, entitled “METHODS AND SYSTEMS FOR SUPPORTING MULTIPLE TRACKING AREA CODES IN A SATELLITE CELL”.

### BACKGROUND

To increase network coverage and support use cases that are beyond the capabilities of ground-based (terrestrial) infrastructure, the 3rd Generation Partnership Project (3GPP) has released standards that integrate non-terrestrial networks (NTNs) into the 5G New Radio (NR) framework. In general, an NTN includes a network, or a segment thereof, which uses airborne or space-borne platforms (e.g., non-geo-stationary satellites) to implement access nodes or base stations.

### SUMMARY

In accordance with one aspect of the present disclosure, a method to be performed by a non-terrestrial access node is disclosed. The method involves receiving a request message from a user equipment (UE) served by the non-terrestrial access node, where the non-terrestrial access node is broadcasting a plurality of tracking area codes (TACs), and where a first TAC is associated with a first tracking area (TA) that is forbidden for the UE. The method further involves sending, to a core network node, the plurality of TACs in at least one information element.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the request message is one of: a registration request message or a service request message.

In some implementations, the method further involves: determining that the UE is located in a second tracking area associated with a second TAC; and including the second TAC in a first information element and a list of the remaining TACs of the plurality in a second information element.

In some implementations, the at least one information element including the plurality of TACs is included in one of an INITIAL UE MESSAGE or UL NAS TRANSPORT message.

In some implementations, the core network node is an Access and Mobility Management Function (AMF).

In some implementations, the plurality of TACs each correspond to one of a plurality of public land mobile networks (PLMNs).

In some implementations, receiving the request from the UE further involves determining that the UE is not registered with the plurality of TACs.

In accordance with another aspect of the present disclosure, a method to be performed by a core network node is disclosed. The method involves receiving a request message associated with a user equipment (UE) located in a tracking area in which a non-terrestrial access node is broadcasting a plurality of tracking area codes (TACs). The method further involves determining whether registration of the UE is successful. The method further involves in response to the determination, generating a response message including one or more TACs of the plurality of TACs, where at least one of the one or more TACs is indicated to be associated with one or more tracking areas (TAs) that are forbidden for the UE.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the method further involves receiving a message including at least one User Location Information (ULI) associated with the UE.

In some implementations, the received message is one of an INITIAL UE MESSAGE or UL NAS TRANSPORT message.

In some implementations, the at least one User Location Information (ULI) includes a first TAC associated with the tracking area where the UE is located and the plurality of TACs broadcasted by the non-terrestrial access node.

In some implementations, determining whether registration of the UE is successful is based on the at least one ULI.

In some implementations, the one or more TACs indicated to be associated with one or more tracking areas (TAs) that are forbidden for the UE are determined based on the at least one ULI.

In some implementations, determining whether registration of the UE is successful involves determining that the registration is unsuccessful, and where the response message is a reject message.

In some implementations, the reject message is one of: a registration reject message, a service reject message, or a network-initiated deregistration request message.

In some implementations, the reject message further includes a reject cause.

In some implementations, the reject cause is one of: a 5GMM cause #12, a 5GMM cause #13, or a 5GMM cause #15.

In some implementations, determining whether registration of the UE is successful involves determining that the registration is successful, and where the response message is a registration accept message.

In some implementations, the registration accept message is a 5GMM Registration Accept message.

In some implementations, the message includes a first TAC of the plurality of TACs, and determining whether registration of the UE is successful involves: determining whether the first TAC is associated with the one or more TAs that are forbidden for the UE; and determining whether the registration is successful in part based on whether the first TAC is associated with the one or more TAs that are forbidden for the UE.

In some implementations, the core network node is an Access and Mobility Management Function (AMF).

In accordance with another aspect of the present disclosure, a method to be performed by a radio access network (RAN) is disclosed. The method involves determining to communicate mobile terminated (MT) data or signaling to user equipment (UE) operating in an idle mode; and initiating a paging procedure in a plurality of cells of a plurality of tracking areas (TAs) in a tracking area identity (TAI) list for the UE, where the plurality of cells include a non-terrestrial network (NTN) cell broadcasting a plurality of tracking area codes (TACs), and where the paging is performed in the NTN cell if a TAC broadcast in the NTN cell is included in the TAI list for the UE.

In accordance with another aspect of the present disclosure, a method to be performed by a user equipment (UE) is disclosed. The method involves determining, based on a stored geographical area description (GAD) of a first tracking area forbidden to the UE, that the UE has entered the first tracking area, and responsively performing a remedial action based on a stored reject cause associated with the first tracking area.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the remedial action is one of: (i) performing a public land mobile network (PLMN) selection, (ii) performing a selection of a cell of a different tracking area of the same PLMN, or (iii) if the UE is in the area defined by the GAD, determining to not attempt to access a non-terrestrial network (NTN) cell that is broadcasting a first tracking area code of the first tracking area and a second tracking area code of a second tracking area, where the second tracking area is permitted to the UE.

In some implementations, the GAD is one of: a circle, ellipse, or a polygon of latitude/altitude positions.

In some implementations, performing one of a plurality of predetermined actions is further based on a type of access restriction.

In some implementations, the method further involves receiving the GAD and the reject cause in a reject message; and storing the GAD and the reject cause in a memory of the UE.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### BRIEF DESCRIPTION OF THE FIGURES

FIG. 1 illustrates an example non-terrestrial network, according to some implementations.

FIG. 2 illustrates a method, according to some implementations.

FIG. 3 illustrates another method, according to some implementations.

FIG. 4 illustrates another method, according to some implementations.

FIG. 5 illustrates another method, according to some implementations.

FIG. 6 is a block diagram of an example device architecture, according to some implementations.

FIG. 7 illustrates an example of a wireless communication system, according to some implementations.

FIG. 8 illustrates an example of infrastructure equipment, according to some implementations

Like reference numbers and designations in the various drawings indicate like elements.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure in the description of the various embodiments with unnecessary detail. For the purposes of the present document, the phrase “A or B” means (A), (B), or (A and B). Although the disclosure generally describes methods and systems in the context of 5G, the disclosed methods and systems can be applied to other generations of wireless communication protocols, such as 4G and 6G (or beyond 6G).

As stated above, the 3rd Generation Partnership Project (3GPP) has released standards that integrate non-terrestrial networks (NTNs) into the 5G New Radio (NR) framework. Existing protocols (e.g., 3GPP agreements) specify that tracking areas (TAs) of NTN cells are allocated to a fixed geographical area. They also specify that an NTN cell can broadcast, e.g., in a System Information Block (SIB), multiple Tracking Area Codes (TACs) per public land mobile network (PLMN). Under these protocols, an NTN cell can serve multiple TAs.

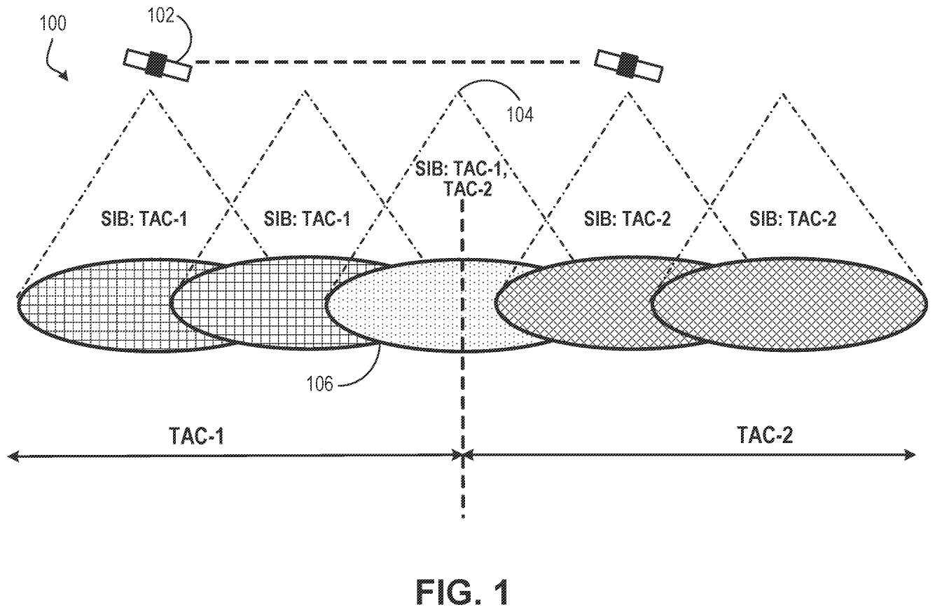

FIG. 1 illustrates an example non-terrestrial network 100, according to some implementations. The non-terrestrial network 100 includes a non-geo-stationary satellite 102 that can serve multiple tracking areas. For example, as shown in FIG. 1, the satellite 102 can serve a first tracking area (TA-1) that has a first tracking area code (TAC-1) and a second tracking area (TA-2) that has a second tracking area code (TAC-2). The tracking areas TA-1 and TA-2 are allocated to fixed geographical areas. When the satellite 102 is above the geographical area of TA-1, the satellite 102 broadcasts TAC-1 and serves UEs located in that geographical area. And when the satellite 102 is above the geographical area of TA-2, the satellite 102 broadcasts TAC-2 and serves UEs located in that geographical area.

The non-terrestrial network 100 is shown for illustration purposes only, as the non-terrestrial network 100 may include additional components or have one or more components removed without departing from the scope of the disclosure. Note that the non-terrestrial network 100 is used to provide illustrative examples of the methods described herein. However, the methods are not limited to the non-terrestrial network 100 and can be applied to other networks.

In practice, as the satellite 102 moves from TA-1 to TA-2, the satellite 102 switches from broadcasting TAC-1 to broadcasting TAC-2. The difficulty of doing so, however, is that the footprint of the satellite cell beam crosses a border between the TAs as it moves from one TA to another. For example, a coverage area 106 of the satellite 102 overlaps the geographical areas associated with both TAs when the satellite 102 is located at position 104. In the border area between TAs, the NTN needs to switch between broadcasting TAC-1 and TAC-2. One solution, called soft-switching, involves the satellite 102 broadcasting both TAC-1 and TAC-2 in the border area between TAs.

However, broadcasting multiple TACs can cause problems for the UE and/or the network. Some of these problems are related to the handling of forbidden tracking areas. Forbidden tracking areas can be used by network operators to configure roaming restrictions for subscribers, e.g., in order to support national roaming between PLMNs. As an example, because of a national roaming agreement between the 2 PLMNs, a first PLMN (“PLMN 1”) may allow a UE, which has a subscription for a second PLMN (“PLMN 2”), to access PLMN 1 in a first tracking area. However, the first PLMN will not allow the UE to access PLMN 1 in a second tracking area. If the UE attempts to access PLMN 1 in the second tracking area, the first PLMN can use a reject message such as a 5GMM Registration Reject message, a 5GMM Service Reject message or a network-initiated 5GMM Deregistration Request message including a 5GMM cause #13 to reject the UE. Using the example of the non-terrestrial network 100, a PLMN associated with TA-1 may allow the UE to have network access in TA-1, but prevents the UE from accessing the same network in TA-2 (which is associated with a different PLMN). When the UE is in TA-2 and attempts to access the network, the UE can receive a reject message including a 5GMM cause #13, which instructs the UE to perform a PLMN selection.

To understand the problems related to the handling forbidden tracking areas, it is important to note that the geographical allocation of a TA is only known to the network. A UE does not know the TA in which it is located when an NTN cell is broadcasting multiple TACs. Thus, if the UE has just entered the NTN cell, the UE may not be able to select the correct TAC when triggering registration. Instead, the UE may rely on the network to select the TAC. In this scenario, the satellite serving the NTN cell indicates the multiple TACs to the Access and Mobility Management Function (AMF) in the core network, which then selects a TAC for the UE, perhaps based on a location of the UE or based on subscription data (e.g., information about forbidden TAs to the UE).

If the network determines that the UE is located in a permitted tracking area, then the registration of the UE is likely to be successful. The network indicates the selected TAC as one of the registered TACs in the tracking area identity (TAI) list information element (IE) in the registration accept message sent to the UE. However, if the network determines that the UE is located in a forbidden TA, then the registration will be unsuccessful, and the network sends a reject message to the UE. In a cell that is broadcasting a single TAC, the UE, upon receiving the reject message, would know that the tracking area associated with the TAC is forbidden, and would add the TAC to a forbidden list. In this scenario, however, the cell is broadcasting multiple TACs, and the UE, upon receiving the reject message, does not know which of the multiple TACs is forbidden. As a result, the UE does not know which cells are suitable for camping.

Thus, a first problem with the existing protocols relates to the UE determining the TAs that are forbidden to the UE. If the network determines that the UE is located in a forbidden TA (e.g., TA-2 in FIG. 1), there are no means in the existing registration reject message to indicate to the UE the forbidden TA (i.e., the TA for which the UE does not have access). Thus, when the UE receives a registration reject message (e.g., a 5GMM Registration Reject message including 5GMM cause #13), it does not know which of the TACs broadcast in the cell it needs to add to the list of forbidden TAs. If, by error, the UE adds the wrong TA to the list of forbidden TAs, then it may be without any service. This deficiency is especially problematic when the cell is broadcasting multiple TACs and the UE has not successfully registered to any of these TACs before entering the cell, e.g., because the UE came from a different TA (e.g., TA-3).

In some embodiments, a reject message (e.g., registration reject, service reject, network-initiated deregistration request, or any other reject message, such as those disclosed in 3GPP TS 24.501) is enhanced to allow the network to send the TACs of the TAs to which the UE does not have access (i.e, the TAs which the UE shall consider as forbidden) together with the reject cause. This reject message can be used when the core network rejects the access attempt due to access restrictions for specific TACs (e g., 5GMM causes #12, #13, #15; see also “partial” PLMN restrictions in TS 22.011, clause 3.2.2.4.2).

In some embodiments, an accept message (e.g., a registration accept message, service accept message, etc.) is also enhanced to allow the network to include the TACs of the TAs to which the UE does not have access (i.e., the TAs which the UE shall consider as forbidden) in addition to the TAI list. In an example, the network can use the registration accept when the UE is located in a cell (e.g., an NTN cell) that is broadcasting multiple TACs.

In some embodiments, these messages (e.g., the reject and/or accept messages) allow the network to serve multiple TAs in an NTN cell, whereby a subset of the TAs can be forbidden for a UE. This, in turn, allows the network to support features that use roaming restrictions, e.g., national roaming (assuming the national roaming is allowed only in certain NTN TAs). This is in contrast to the existing 5GMM messages, which do not enable the UE to determine which of the multiple TAs are forbidden. By also providing the TAs to which the UE does not have access also in the 5GMM accept messages (e.g., registration accept, service accept), it is possible to avoid unnecessary registration attempts to these forbidden TAs.

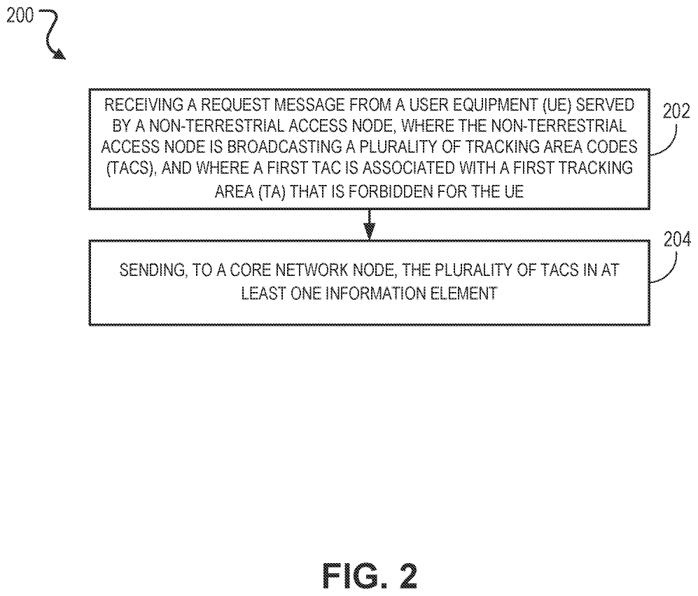

FIG. 2 illustrates a method 200, according to some implementations of the present disclosure. For clarity of presentation, the description that follows generally describes method 200 in the context of the other figures in this description. For example, method 200 can be performed by a network entity, e.g., a non-terrestrial access node, such as satellite 102. However, it will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

At 202, the method 200 involves receiving a request message from a user equipment (UE) served by the non-terrestrial access node, where the non-terrestrial access node is broadcasting a plurality of tracking area codes (TACs), and where a first TAC is associated with a first tracking area (TA) that is forbidden for the UE.

At 204, the method 200 involves sending, to a core network node, the plurality of TACs in at least one information element.

In some implementations, the request message is one of: a registration request message or a service request message.

In some implementations, the method 200 further involves determining that the UE is located in a second tracking area associated with a second TAC; and including the second TAC in a first information element and a list of the remaining TACs of the plurality in a second information element.

In some implementations, the at least one information element is included in one of an INITIAL UE MESSAGE or UL NAS TRANSPORT message (such as those disclosed in 3GPP TS 38.413).

In some implementations, the core network node is an Access and Mobility Management Function (AMF).

In some implementations, the plurality of TACs each correspond to one of a plurality of public land mobile networks (PLMNs).

In some implementations, receiving the request from the UE further involves determining that the UE is not registered with the plurality of TACs.

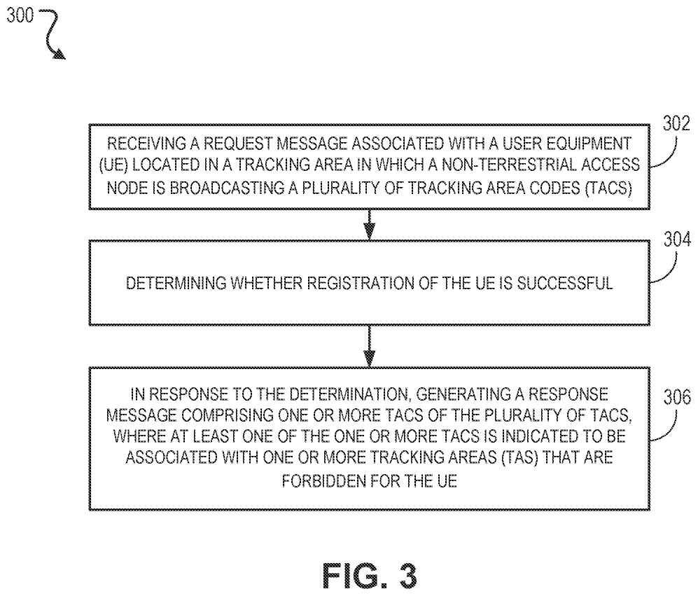

FIG. 3 illustrates a method 300, according to some implementations of the present disclosure. For clarity of presentation, the description that follows generally describes method 300 in the context of the other figures in this description. For example, method 300 can be performed by a network entity, e.g., Access and Mobility Management Function (AMF). However, it will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At 302, the method 300 involves receiving a request message associated with a user equipment (UE) located in a tracking area in which a non-terrestrial access node is broadcasting a plurality of tracking area codes (TACs).

At 304, the method 300 involves determining whether registration of the UE is successful.

At 306, the method 300 involves in response to the determination, generating a response message including one or more TACs of the plurality of TACs, where at least one of the one or more TACs is indicated to be associated with one or more tracking areas (TAs) that are forbidden for the UE.

In some implementations, the method 300 further involves receiving a message including at least one User Location Information (ULI) associated with the UE.

In some implementations, the received message is one of an INITIAL UE MESSAGE or UL NAS TRANSPORT message (such as those disclosed in 3GPP TS 38.413).

In some implementations, the at least one User Location Information (ULI) includes the TAC associated with the tracking area where the UE is located and the plurality of TACs broadcasted by the non-terrestrial access node.

In some embodiments, the TAC associated with the location of the UE is sent in a separate IE, separate from the remaining plurality of TACs, which are sent in a different IE.

In some implementations, determining whether registration of the UE is successful is based on the at least one ULI.

In some implementations, the one or more TACs indicated to be associated with one or more tracking areas (TAs) that are forbidden for the UE are determined based on the at least one ULI.

In some implementations, determining whether registration of the UE is successful involves determining that the registration is unsuccessful, and the response message is a reject message.

In some implementations, the reject message is one of: a registration reject message, a service reject message, or a network-initiated deregistration request message.

In some implementations, the reject message further includes a reject cause.

In some implementations, the reject cause is one of: a 5GMM cause #12, a 5GMM cause #13, or a 5GMM cause #15.

In some implementations, determining whether registration of the UE is successful involves determining that the registration is successful, and the response message is a registration accept message.

In some implementations, the registration accept message is a 5GMM Registration Accept message.

In some implementations, the message including at least one User Location Information (ULI) associated with the UE includes a first TAC of the plurality of TACs, and where determining whether registration of the UE is successful involves: determining whether the first TAC is associated with the one or more TAs that are forbidden for the UE; determining whether the registration is successful in part based on whether the first TAC is associated with the one or more TAs that are forbidden for the UE.

In some implementations, the network entity receives the request message included in an INITIAL UE MESSAGE or UL NAS TRANSPORT message. So, e.g., the request message is included in an information element in the INITIAL UE MESSAGE, and the ULI (which includes the TAC) is another information element in this INITIAL UE MESSAGE.

A second problem is related to paging in forbidden TAs Turning back to FIG. 1, assuming a UE is located at the border between TA-1 and TA-2, the UE can move from TA-1 into TA-2, while staying in the zone where the satellite 102 is broadcasting both TAC-1 and TAC-2 most of the time. As the UE is registered in TA-1, the UE will not trigger a registration request and will not search for a different PLMN (or in a national roaming scenario, the home PLMN [HPLMN]). Rather, the UE will assume it is still allowed to access the network. However, once the UE attempts to request a service, the network will determine that the UE is located in the forbidden area (e.g., TA-2) and will reject the service request. Note that the UE can become aware of being located in TA-2 once the moving NTN cell leaves the geographical area of TA-1 and stops broadcasting TAC-1 in the SIBs. But dependent on the UE's distance from the border between TAC-1 and TAC-2, after a short time the UE can get into coverage of the next moving NTN cell broadcasting TAC-1 and TAC-2, so in consequence, the UE may spend some time in the forbidden TA (e.g., TA-2) and may erroneously assume that it can get service on the NTN cell in its current location via TA-1.

When the network needs to deliver mobile terminated (MT) user data or signaling to a UE in idle mode, the network pages the UE within the TAs of the TAI list where the UE is registered. If the network performs paging only in the NTN cells that are strictly within the fixed geographical area associated with a certain TA (e.g. TA-1), then a UE located in a forbidden TA (e.g, TA-2), erroneously assuming that it can get service via TA-1, will not be paged. So, the UE will not be triggered to respond with a service request, and it will not detect that it is actually in a forbidden TA and needs to perform PLMN selection.

In some embodiments, when the network intends to deliver MT data or MT signaling to a UE in idle mode, the network initiates a paging procedure in all cells of the TAs of the TAI list, including the NTN cells serving multiple TAs (i.e., broadcasting multiple TACs). The network does so irrespective of the assumed current location of the UE and the TAC associated with that location (that is, even if the network assumes that geographically the UE is in a forbidden TA). Thus, if the NTN cell is broadcasting both a forbidden TAC and a TAC included the UE's TAI list, the UE is paged in that cell.

These embodiments ensure that pending MT user data or signaling will be indicated to the UE in idle mode even if the UE is in a geographical position that is covered by a TAC forbidden for the UE. In response to receiving the paging, the UE will attempt to access the network, receive a 5GMM reject message, and perform a remedial action (e.g., performing a PLMN or cell selection) to find a cell where it can get service-instead of staying camped on the cell in the forbidden TA.

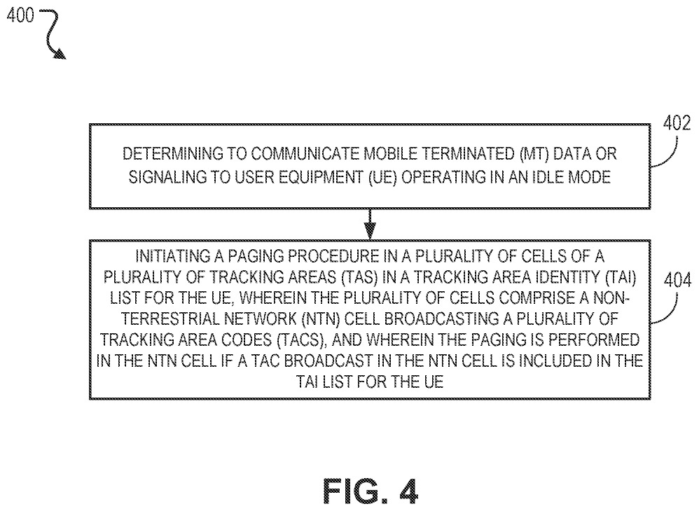

FIG. 4 illustrates a method 400, according to some implementations of the present disclosure. For clarity of presentation, the description that follows generally describes method 400 in the context of the other figures in this description. For example, method 400 can be performed by a network, e.g, a radio access network (RAN), or one or more entities thereof. However, it will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At 402, the method 400 involves determining to communicate mobile terminated (MT) data or signaling to user equipment (UE) operating in an idle mode.

At 404, the method 400 involves initiating a paging procedure in a plurality of cells of a plurality of tracking areas (TAs) in a tracking area identity (TAI) list for the UE, where the plurality of cells include a non-terrestrial network (NTN) cell broadcasting a plurality of tracking area codes (TACs), and where the paging is performed in the NTN cell if a TAC broadcast in the NTN cell is included in the TAI list for the UE.

A third problem is related to delayed PLMN selection. According to the 3GPP specifications (e.g., TS 23 122, TS 24.501), if upon receipt of 5GMM reject cause #13 the UE determines that the current TAC is forbidden, the UE performs a PLMN selection in order to select a PLMN that can provide service to the UE (e.g., the HPLMN). Currently, in scenarios where a cell is broadcasting multiple TACs, the PLMN selection is delayed, because the UE will determine that it is located in the forbidden TA (e.g., TA-2) only once it requests service or it detects that the NTN cell is no longer broadcasting a registered tracking area code (e.g., TAC-1). This can affect the user experience, because when the user requests service, the user has to wait until the UE has completed the selection of and registration to the new PLMN.

In some embodiments, if the core network rejects the access due to access restrictions for specific TACs (e.g., 5GMM causes #12, #13, #15), it provides the UE with a geographical area description (GAD) of the TAC that is forbidden for the UE. The GAD can be a circle, ellipse or a polygon of latitude/altitude positions (e.g., the GADs described in 3GPP TS 23.032). The UE stores the GAD of the TAC and an associated reject cause or type of access restriction (e.g., 5GMM cause #12, #13, or #15). Then, if the UE detects that it has entered a forbidden TA in a PLMN, for which it has stored the geographical area description and the type of access restriction, the UE is configured to trigger the actions defined for the case when receiving the respective 5GMM cause. For example, if the forbidden TA is associated with 5GMM cause #13, the UE triggers a PLMN selection.

In some embodiments, if the UE is within the geographical area description of a forbidden TA (e.g., TA-2), the UE is configured to not attempt to access an NTN cell broadcasting the TAC of the forbidden TA even if that cell is broadcasting additional TACs that are not forbidden for the UE (e.g., TAC-1).

These embodiments enable a UE to detect that it enters a forbidden TA in a satellite cell that broadcasts multiple TACs, and to responsively perform the desired UE action (e.g., PLMN selection). Therefore, the scenario of the network rejecting the UE once it requests the service is avoided, thereby avoiding the delay associated with this scenario. As described, this scenario would result in a significant delay to establish the connection required for the service, as the UE would first trigger a PLMN or cell selection before it could re-attempt to establish the connection for the pending service. In the case of an MT service, staying on the cell in the forbidden TA can even result in a service loss (e g., loss of an MT call).

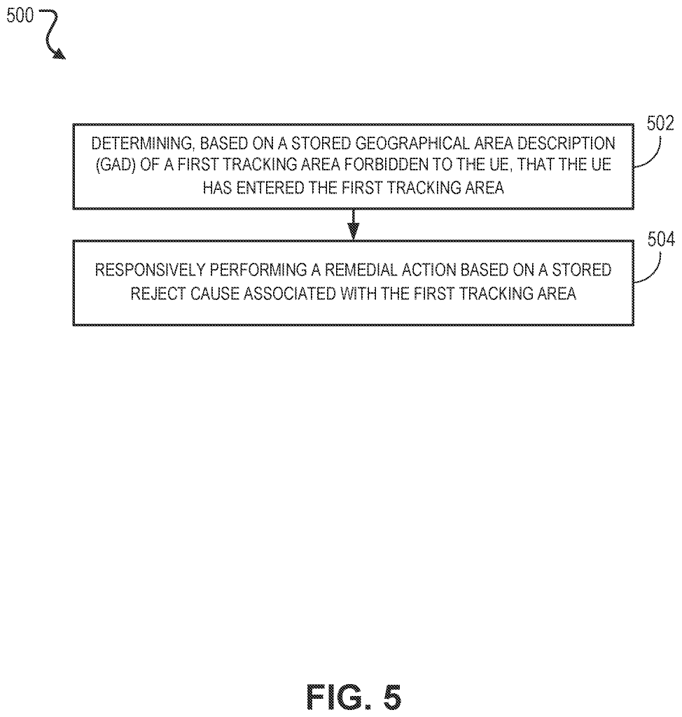

FIG. 5 illustrates a method 500, according to some implementations of the present disclosure. For clarity of presentation, the description that follows generally describes method 500 in the context of the other figures in this description. For example, method 500 can be performed by a user equipment (UE). However, it will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At 502, the method 500 involves determining, based on a stored geographical area description (GAD) of a first tracking area forbidden to the UE, that the UE has entered the first tracking area.

At 504, the method 500 involves responsively performing a remedial action based on a stored reject cause associated with the first tracking area.

In some implementations, the remedial action is one of: (i) performing a PLMN selection, (ii) performing a selection of a cell of a different tracking area of the same PLMN, or (iii) if the UE is in the area defined by the GAD, determining to not attempt to access a non-terrestrial network (NTN) cell that is broadcasting a first tracking area code of the first tracking area and a second tracking area code of a second tracking area, where the second tracking area is permitted to the UE.

In some implementations, the GAD is one of: a circle, ellipse, or a polygon of latitude/altitude positions.

In some implementations, performing one of a plurality of predetermined actions is further based on a type of access restriction.

5GMM cause #12 indicates that the tracking area is not allowed. The 5GMM cause is sent to the UE if it requests service, or if the network initiates a de-registration request, in a tracking area where the HPLMN determines that the UE, by subscription, is not allowed to operate. In some implementations, for cause #12, the UE stays camped on the current (forbidden) cell and performs cell re-selection if another cell is providing better radio conditions.

5GMM cause #13 indicates that roaming is not allowed in this tracking area. The 5GMM cause is sent to a UE which requests service, or if the network initiates a de-registration request, in a tracking area of a PLMN which by subscription offers roaming to that UE but not in that tracking area. In some implementations, for cause #13, the UE is configured to perform a PLMN selection.

5GMM cause #15 indicates that there are no suitable cells in the tracking area. The 5GMM cause is sent to the UE if it requests service, or if the network initiates a de-registration request, in a tracking area where the UE, by subscription, is not allowed to operate, but when it should find another allowed tracking area in the same PLMN or an equivalent PLMN. In some implementations, for cause #15, the UE selects a cell in a different TA of the same PLMN. This different TA can be a TA of the same radio access technology (e.g., a satellite NR), but can alternatively be a terrestrial cell (if available).

In some implementations, the method 500 further involves receiving the GAD and the reject cause in a reject message; and storing the GAD and the reject cause in a memory of the UE.

Also disclosed are one or more systems of one or more computers configured to perform particular operations or actions by virtue of having software, firmware, hardware, or a combination of them installed on the system that in operation causes or cause the system to perform the actions of the method 200, the method 300, the method 400, and/or the method 500. One or more computer programs can be configured to perform particular operations or actions by virtue of including instructions that, when executed by data processing apparatus, cause the apparatus to perform the actions of the method 200, the method 300, the method 400, and/or the method 500.

Other embodiments of this aspect include corresponding computer systems, apparatus, and computer programs recorded on one or more computer storage devices, each configured to perform the actions of the method 200, the method 300, the method 400, and/or the method 500.

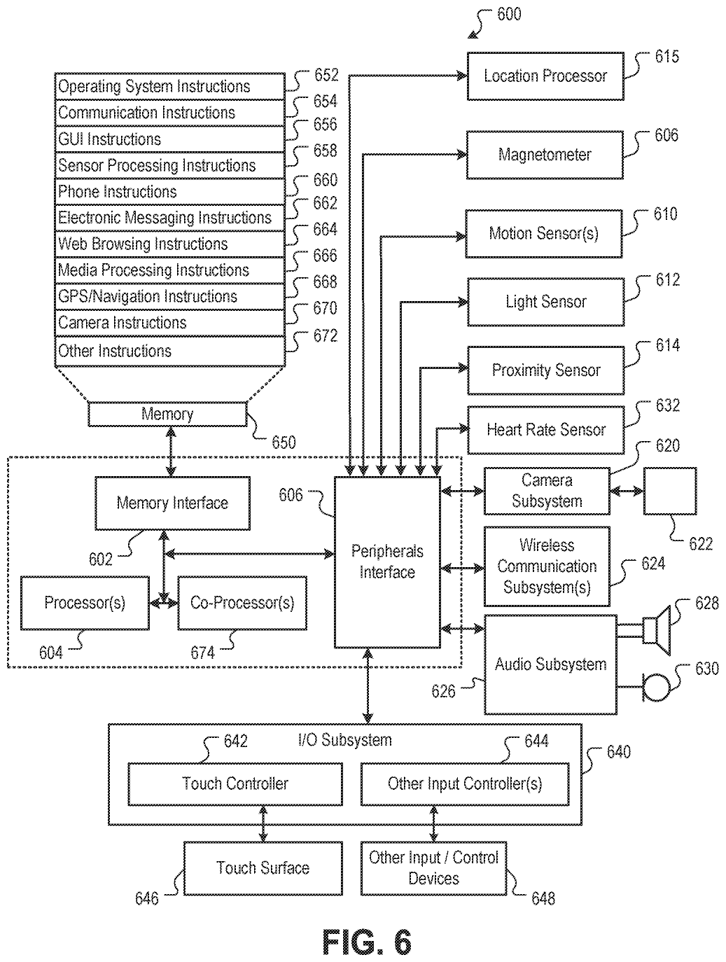

FIG. 6 is a block diagram of an example device architecture 600 for implementing the features and processes described in reference to FIGS. 1-5. For example, the architecture 600 can be used to implement a user device. Architecture 600 may be implemented in any device for generating the features described in reference to FIGS. 1-5, including but not limited to desktop computers, server computers, portable computers, smart phones, tablet computers, game consoles, wearable computers, set top boxes, media players, smart TVs, and the like.

The architecture 600 can include a memory interface 602, one or more data processor 604, one or more data co-processors 674, and a peripherals interface 606. The memory interface 602, the processor(s) 604, the co-processor(s) 674, and/or the peripherals interface 606 can be separate components or can be integrated in one or more integrated circuits. One or more communication buses or signal lines may couple the various components.

The processor(s) 604 and/or the co-processor(s) 674 can operate in conjunction to perform the operations described herein. For instance, the processor(s) 604 can include one or more central processing units (CPUs) that are configured to function as the primary computer processors for the architecture 600. As an example, the processor(s) 604 can be configured to perform generalized data processing tasks of the architecture 600. Further, at least some of the data processing tasks can be offloaded to the co-processor(s) 674. For example, specialized data processing tasks, such as processing motion data, processing image data, encrypting data, and/or performing certain types of arithmetic operations, can be offloaded to one or more specialized co-processor(s) 674 for handling those tasks. In some cases, the processor(s) 604 can be relatively more powerful than the co-processor(s) 674 and/or can consume more power than the co-processor(s) 674. This can be useful, for example, as it enables the processor(s) 604 to handle generalized tasks quickly, while also offloading certain other tasks to co-processor(s) 674 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 604 for further analysis.

In some implementations, the processors 604 are configured to determine, based on a stored geographical area description (GAD) of a first tracking area forbidden to the UE, that the UE has entered the first tracking area. Additionally, the processors 604 are configured to responsively perform a remedial action based on a stored reject cause associated with the first tracking area. In some implementations, the remedial action is one of: (i) performing a PLMN selection, (ii) performing a selection of a cell of a different tracking area of the same PLMN, or (iii) if the UE is in the area defined by the GAD, determining to not attempt to access a non-terrestrial network (NTN) cell that is broadcasting a first tracking area code of the first tracking area and a second tracking area code of a second tracking area, where the second tracking area is permitted to the UE. In some implementations, the GAD is one of: a circle, ellipse, or a polygon of latitude/altitude positions. In some implementations, performing one of a plurality of predetermined actions is further based on a type of access restriction.

Sensors, devices, and subsystems can be coupled to peripherals interface 606 to facilitate multiple functionalities. For example, a motion sensor 610, a light sensor 612, and a proximity sensor 614 can be coupled to the peripherals interface 606 to facilitate orientation, lighting, and proximity functions of the architecture 600.

Other sensors may also be connected to the peripherals interface 606, such as a temperature sensor, a biometric sensor, or other sensing device, to facilitate related functionalities. As an example, as shown in FIG. 6, the architecture 600 can include a heart rate sensor 632 that measures the beats of a user's heart. Similarly, these other sensors also can be directly integrated into one or more co-processor(s) 674 configured to process measurements obtained from those sensors.

A location processor 615 can be connected to the peripherals interface 606 to provide geo-referencing. An electronic magnetometer 616 (e.g., an integrated circuit chip) can also be connected to the peripherals interface 606 to provide data that may be used to determine the direction of magnetic North. Thus, the electronic magnetometer 616 can be used as an electronic compass.

A camera subsystem 620 and an optical sensor 622 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 624. The communication subsystem(s) 624 can include one or more wireless and/or wired communication subsystems. For example, wireless communication subsystems can include radio frequency receivers and transmitters and/or optical (e.g, infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 624 can depend on the communication network(s) or medium(s) over which the architecture 600 is intended to operate. For example, the architecture 600 can include wireless communication subsystems designed to operate over an LTE network, a 5G NR network, a 6G (or later) network, 802.x communication networks (e.g., Wi-Fi, Wi-Max), code division multiple access (CDMA) networks, NFC and a Bluetooth™ network. The wireless communication subsystems can also include hosting protocols such that the architecture 600 can be configured as a base station for other wireless devices. As another example, the communication subsystems 624 may allow the architecture 600 to synchronize with a host device using one or more protocols.

An audio subsystem 626 can be coupled to a speaker 628 and one or more microphones 630 to facilitate voice-enabled functions, such as voice recognition, voice replication, digital recording, and telephony functions.

An I/O subsystem 640 can include a touch controller 642 and/or other input controller(s) 644. The touch controller 642 can be coupled to a touch surface 646. The touch surface 646 and the touch controller 642 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 646. In one implementations, the touch surface 646 can display virtual or soft buttons and a virtual keyboard, which can be used as an input/output device by the user.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

A memory interface 602 can be coupled to a memory 650. The memory 650 can include high-speed random access memory or non-volatile memory, such as one or more magnetic disk storage devices, one or more optical storage devices, or flash memory. The memory 650 can store an operating system 652, such as LINUX, UNIX, OS X, WINDOWS, iOS. The operating system 652 can include instructions for handling basic system services and for performing hardware dependent tasks.

The memory 650 can also store communication instructions 654 to facilitate communicating with one or more additional devices, one or more computers or servers, including peer-to-peer communications. The communication instructions 654 can also be used to select an operational mode or communication medium for use by the device, based on a geographic location (obtained by the GPS/Navigation instructions 668) of the device. The memory 650 can include graphical user interface instructions 656 to facilitate graphic user interface processing, including a touch model for interpreting touch inputs and gestures; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes; camera instructions 670 to facilitate camera-related processes and functions; and other instructions 672 for performing some or all of the processes described herein.

Each of the above identified instructions and applications can correspond to a set of instructions for performing one or more functions described herein. These instructions need not be implemented as separate software programs, procedures, or modules. The memory 1650 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, and flash memory devices; magnetic disks such as internal hard disks and removable disks; magneto-optical disks, and CD-ROM and DVD-ROM disks. The processor and the memory may be supplemented by, or incorporated in, ASICs (application-specific integrated circuits).

To provide for interaction with a user the features may be implemented on a computer having a display device for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

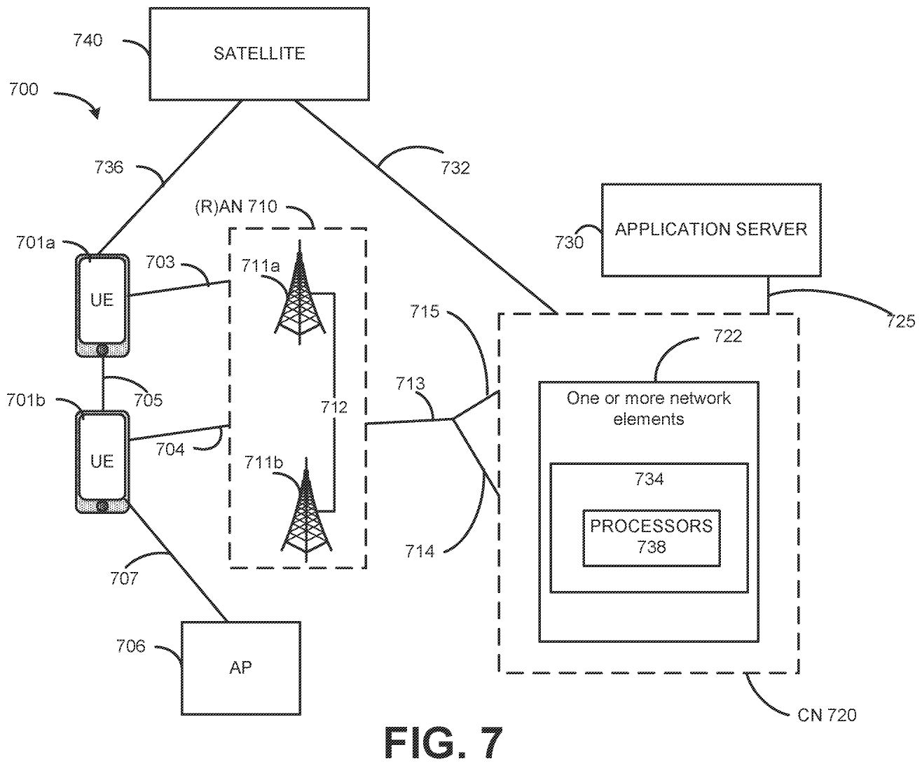

FIG. 7 illustrates an example of a wireless communication system 700, according to some implementations. The wireless communication system 700 may include or communicate with the non-terrestrial network 100. For purposes of convenience and without limitation, the example system 700 is described in the context of Long Term Evolution (LTE) and Fifth Generation (5G) New Radio (NR) communication standards as defined by the Third Generation Partnership Project (3GPP) technical specifications. More specifically, the wireless communication system 700 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 700 may also be a Standalone (SA) network that incorporates only NR. Furthermore, other types of communication standards are possible, including future 3GPP systems (e.g., Sixth Generation (6G)) systems, IEEE 802.16 protocols (e.g., WiMAX, etc.), or the like.

As shown by FIG. 7, the system 700 includes UE 701a and UE 701b (collectively referred to as “UEs 701” or “UE 701”). In this example, UEs 701 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, wireless handsets, desktop computers, laptop computers, and/or the like.

The UEs 701 may be configured to connect, for example, communicatively couple, with RAN 710. In embodiments, the RAN 710 may be an NG RAN or a 5G RAN, an E-UTRAN, or a legacy RAN, such as a UTRAN. As used herein, the term “NG RAN” or the like may refer to a RAN 710 that operates in an NR or 5G system, and the term “E-UTRAN” or the like may refer to a RAN 710 that operates in an LTE or 4G system. The UEs 701 utilize connections (or channels) 703 and 704, respectively, each of which comprises a physical communications interface or layer (discussed in further detail below).

In this example, the connections 703 and 704 are illustrated as an air interface to enable communicative coupling, and can be consistent with cellular communications protocols, such as a GSM protocol, a CDMA network protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UEs 701 may directly exchange communication data via a ProSe interface 705. The ProSe interface 705 may alternatively be referred to as a sidelink interface 705.

The UE 701b is shown to be configured to access an AP 706 via connection 707. The connection 707 can comprise a local wireless connection, such as a connection consistent with any IEEE 802.11 protocol, wherein the AP 706 would comprise a wireless fidelity (Wi-Fi®) router. In this example, the AP 706 is shown to be connected to the Internet without connecting to the core network of the wireless system (described in further detail below).

The RAN 710 can include one or more AN nodes or RAN nodes 711a and 711b (collectively referred to as “RAN nodes 711” or “RAN node 711”) that enable the connections 703 and 704. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 711 that operates in an NR or 5G system (for example, a gNB), and the term “E-UTRAN node” or the like may refer to a RAN node 711 that operates in an LTE or 4G system (e.g., an eNB). According to various embodiments, the RAN nodes 711 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 711 may be implemented as one or more software entities running on server computers as part of a virtual network.

Any of the RAN nodes 711 can terminate the air interface protocol and can be the first point of contact for the UEs 701. In some embodiments, any of the RAN nodes 711 can fulfill various logical functions for the RAN 710 including, but not limited to, radio network controller (RNC) functions such as radio bearer management, uplink and downlink dynamic radio resource management and data packet scheduling, and mobility management.

In embodiments, the UEs 701 can be configured to communicate using OFDM communication signals with each other or with any of the RAN nodes 711 over a multicarrier communication channel in accordance with various communication techniques, such as, but not limited to, an OFDMA communication technique (e.g., for downlink communications) or a SC-FDMA communication technique (e.g, for uplink and ProSe or sidelink communications), although the scope of the embodiments is not limited in this respect. The OFDM signals can comprise a plurality of orthogonal subcarriers.

According to various embodiments, the UEs 701 and the RAN nodes 711 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band. NR in the unlicensed spectrum may be referred to as NR-U, and LTE in an unlicensed spectrum may be referred to as LTE-U, licensed assisted access (LAA), or MulteFire.

To operate in the unlicensed spectrum, the UEs 701 and the RAN nodes 711 may operate using LAA, eLAA, and/or feLAA mechanisms. In these implementations, the UEs 701 and the RAN nodes 711 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The RAN 710 is shown to be communicatively coupled to a core network-in this embodiment, core network (CN) 720. The CN 720 may comprise a plurality of network elements 722 (e.g, AMF OR MME 734), which are configured to offer various data and telecommunications services to customers/subscribers (e.g., users of UEs 701) who are connected to the CN 720 via the RAN 710. The components of the CN 720 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 720 may be referred to as a network slice, and a logical instantiation of a portion of the CN 720 may be referred to as a network sub-slice. NFV architectures and infrastructures may be used to virtualize one or more network functions, alternatively performed by proprietary hardware, onto physical resources comprising a combination of industry-standard server hardware, storage hardware, or switches.

Generally, the application server 730 may be an element offering applications that use IP bearer resources with the core network (e.g., UMTS PS domain, LTE PS data services, etc.). The application server 730 can also be configured to support one or more communication services (e.g., VoIP sessions, PTT sessions, group communication sessions, social networking services, etc.) for the UEs 701 via the EPC 720.

In embodiments, the CN 720 may be a 5GC (referred to as “5GC 720” or the like), and the RAN 710 may be connected with the CN 720 via an NG interface 713. In embodiments, the NG interface 713 may be split into two parts, an NG user plane (NG-U) interface 714, which carries traffic data between the RAN nodes 711 and a UPF, and the S1 control plane (NG-C) interface 715, which is a signaling interface between the RAN nodes 711 and AMFs.

In embodiments, the CN 720 may be a 5G CN (referred to as “5GC 720” or the like), while in other embodiments, the CN 720 may be an EPC). Where CN 720 is an EPC (referred to as “EPC 720” or the like), the RAN 710 may be connected with the CN 720 via an S1 interface 713. In embodiments, the S1 interface 713 may be split into two parts, an S1 user plane (S1-U) interface 714, which carries traffic data between the RAN nodes 711 and the S-GW, and the S1-MME interface 715, which is a signaling interface between the RAN nodes 711 and MMEs.

As also shown in FIG. 7, the wireless system 700 may include or communicate with a non-geo-stationary satellite 740 (“satellite 740”). The satellite 740 may be the same as or similar to the non-geo-stationary satellite 102 of FIG. 1. The UEs 701 can communicate with the satellite 740 via connection 736. The connection 736 is illustrated as an air interface to enable communicative coupling, and can be consistent with cellular communications protocols. As shown in FIG. 7, the satellite 740 may communicate with the CN 720 via connection 732. For example, the satellite 740 may communicate with the AMF 734 via an N2 link.

In some implementations, the AMF 734 includes one or more processor(s) 738, for example, one or more processor cores (CPUs), one or more application processors, one or more graphics processing units (GPUs), one or more Acorn RISC Machine (ARM) processors, one or more digital signal processors (DSP), one or more FPGAs, one or more microprocessors or controllers, or any suitable combination thereof.

In some implementations, the one or more processor(s) 738 are configured to receive a request message associated with a user equipment (UE) located in a tracking area in which a non-terrestrial access node is broadcasting a plurality of tracking area codes (TACs). Additionally, the one or more processor(s) 738 are configured to determine whether registration of the UE is successful. Further, the one or more processor(s) 738 are configured to, in response to the determination, generate a response message including one or more TACs of the plurality of TACs, where at least one of the one or more TACs is indicated to be associated with one or more tracking areas (TAs) that are forbidden for the UE. In some implementations, the one or more processor(s) 738 are further configured to receive a message including at least one User Location Information (ULI) associated with the UE.

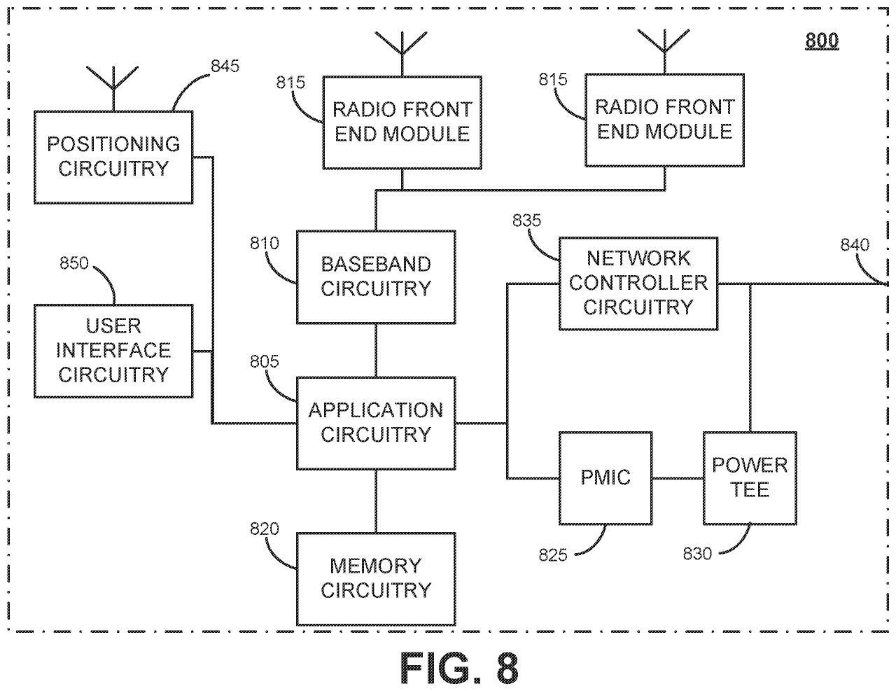

FIG. 8 illustrates an example of infrastructure equipment 800, according to some implementations. The infrastructure equipment 800 (or “system 800”) may be implemented as a base station, radio head, non-terrestrial base station (e.g., non-geo-stationary satellite 102 of FIG. 1 or satellite 740 of FIG. 7), RAN node such as the RAN nodes 711 and/or AP 706 shown and described previously, application server(s) 730, and/or any other element/device discussed herein. In other examples, the system 800 could be implemented in or by a UE.

The system 800 includes application circuitry 805, baseband circuitry 810, one or more radio front end modules (RFEMs) 815, memory circuitry 820, power management integrated circuitry (PMIC) 825, power tee circuitry 830, network controller circuitry 835, network interface connector 840, satellite positioning circuitry 845, and user interface 850. In some embodiments, the device 800 may include additional elements such as, for example, memory/storage, display, camera, sensor, or input/output (I/O) interface. In other embodiments, the components described below may be included in more than one device.

Application circuitry 805 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O) or IO), memory card controllers, Universal Serial Bus (USB) interfaces. The processors (or cores) of the application circuitry 805 may be coupled with or may include memory/storage elements and may be configured to execute instructions stored in the memory/storage to enable various applications or operating systems to run on the system 800.

In some implementations, the application circuitry 805, as part of a non-terrestrial access node, is configured to receive a request message from a user equipment (UE) served by the non-terrestrial access node, where the non-terrestrial access node is broadcasting a plurality of tracking area codes (TACs), and where a first TAC is associated with a first tracking area (TA) that is forbidden for the UE. Further, the application circuitry as 805 is configured to send, to a core network node, the plurality of TACs in at least one information element.

In some implementations, the application circuitry 805, as part of radio access network (RAN), is configure to determining to communicate mobile terminated (MT) data or signaling to user equipment (UE) operating in an idle mode. Further, the application circuitry 805 is configured to initiate a paging procedure in a plurality of cells of a plurality of tracking areas (TAs) in a tracking area identity (TAI) list for the UE, where the plurality of cells include a non-terrestrial network (NTN) cell broadcasting a plurality of tracking area codes (TACs), and where the paging is performed in the NTN cell if a TAC broadcast in the NTN cell is included in the TAI list for the UE.

In some implementations, the memory circuitry 820 may be on-chip memory circuitry, which may include any suitable volatile and/or non-volatile memory, such as dynamic random access memory (DRAM), static random access memory (SRAM), erasable programmable read-only memory (EPROM), electrically erasable programmable read-only memory (EEPROM), Flash memory, solid-state memory, and/or any other type of memory device technology, such as those discussed herein.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 805 may comprise, or may be, a special-purpose processor/controller to operate according to the various embodiments herein.

The baseband circuitry 810 may be implemented, for example, as a solder-down substrate including one or more integrated circuits, a single packaged integrated circuit soldered to a main circuit board or a multi-chip module containing two or more integrated circuits.

User interface circuitry 850 may include one or more user interfaces designed to enable user interaction with the system 800 or peripheral component interfaces designed to enable peripheral component interaction with the system 800. User interfaces may include, but are not limited to, one or more physical or virtual buttons (e.g., a reset button), one or more indicators (e g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 815 may comprise a millimeter wave (mmWave) RFEM and one or more sub-mmWave radio frequency integrated circuits (RFICs). In some implementations, the one or more sub-mmWave RFICs may be physically separated from the mm Wave RFEM. The RFICs may include connections to one or more antennas or antenna arrays, and the RFEM may be connected to multiple antennas In alternative implementations, both mm Wave and sub-mmWave radio functions may be implemented in the same physical RFEM 815, which incorporates both mm Wave antennas and sub-mm Wave.

The PMIC 825 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 830 may provide for electrical power drawn from a network cable to provide both power supply and data connectivity to the infrastructure equipment 800 using a single cable.

The network controller circuitry 835 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 800 via network interface connector 840 using a physical connection, which may be electrical (commonly referred to as a “copper interconnect”), optical, or wireless. The network controller circuitry 835 may include one or more dedicated processors and/or FPGAs to communicate using one or more of the aforementioned protocols. In some implementations, the network controller circuitry 835 may include multiple controllers to provide connectivity to other networks using the same or different protocols.

The positioning circuitry 845 includes circuitry to receive and decode signals transmitted/broadcasted by a positioning network of a global navigation satellite system (GNSS). Examples of navigation satellite constellations (or GNSS) include United States' Global Positioning System (GPS) or the like. The positioning circuitry 845 comprises various hardware elements (e.g., including hardware devices such as switches, filters, amplifiers, antenna elements, and the like to facilitate OTA communications) to communicate with components of a positioning network, such as navigation satellite constellation nodes. The positioning circuitry 845 may also be part of, or interact with, the baseband circuitry 810 and/or RFEMs 815 to communicate with the nodes and components of the positioning network. The positioning circuitry 845 may also provide position data and/or time data to the application circuitry 805, which may use the data to synchronize operations with various infrastructure (e.g., RAN nodes 711, etc.), or the like.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize or otherwise reduce risks of unintentional or unauthorized access or use, and the nature of authorized use should be clearly indicated to users.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1-22. (canceled)

23. One or more processors configured to cause a non-terrestrial access node to perform operations comprising:
receiving a request message from a user equipment (UE) served by the non-terrestrial access node, wherein the non-terrestrial access node is broadcasting a plurality of tracking area codes (TACs), and wherein a first TAC is associated with a first tracking area (TA) that is forbidden for the UE; and
sending, to a core network node, the plurality of TACs in at least one information element.

24. The one or more processors of claim 23, wherein the request message is one of: a registration request message or a service request message.

25. The one or more processors of claim 23, the operations further comprising:
determining that the UE is located in a second tracking area associated with a second TAC; and
including the second TAC in a first information element and a list of the remaining TACs of the plurality in a second information element.

26. The one or more processors of claim 23, wherein the at least one information element is included in one of an INITIAL UE MESSAGE or UL NAS TRANSPORT message.

27. The one or more processors of claim 23, wherein the core network node is an Access and Mobility Management Function (AMF).

28. The one or more processors of claim 23, wherein the plurality of TACs each correspond to one of a plurality of public land mobile networks (PLMNs).

29. The one or more processors of claim 23, wherein receiving the request message from the UE further comprises determining that the UE is not registered with the plurality of TACs.

30. One or more processors configured to cause a core network node to perform operations comprising:
receiving a request message associated with a user equipment (UE) located in a tracking area in which a non-terrestrial access node is broadcasting a plurality of tracking area codes (TACs);
determining whether registration of the UE is successful; and
in response to the determination, generating a response message comprising one or more TACs of the plurality of TACs, wherein at least one of the one or more TACs is indicated to be associated with one or more tracking areas (TAs) that are forbidden for the UE.

31. The one or more processors of claim 30, the operations further comprising receiving a message including at least one User Location Information (ULI) associated with the UE.

32. The one or more processors of claim 31, wherein the received request message is one of an INITIAL UE MESSAGE or UL NAS TRANSPORT message.

33. The one or more processors of claim 31, wherein the at least one User Location Information (ULI) includes a first TAC associated with the tracking area where the UE is located and the plurality of TACs broadcasted by the non-terrestrial access node.

34. The one or more processors of claim 33, wherein determining whether registration of the UE is successful is based on the at least one ULI.

35. The one or more processors of claim 33, wherein the one or more TACs indicated to be associated with one or more tracking areas (TAs) that are forbidden for the UE are determined based on the at least one ULI.

36. The one or more processors of claim 30, wherein determining whether registration of the UE is successful comprises determining that the registration is unsuccessful, and wherein the response message is a reject message.

37. The one or more processors of claim 36, wherein the reject message further comprises a reject cause.

38. The one or more processors of claim 30, wherein determining whether registration of the UE is successful comprises determining that the registration is successful, and wherein the response message is a registration accept message.

39. The one or more processors of claim 30, wherein the request message comprises a first TAC of the plurality of TACs, and wherein determining whether registration of the UE is successful comprises:
determining whether the first TAC is associated with the one or more TAs that are forbidden for the UE; and
determining whether the registration is successful in part based on whether the first TAC is associated with the one or more TAs that are forbidden for the UE.

40. A method to be performed by a non-terrestrial access node, the method comprising:
receiving a request message from a user equipment (UE) served by the non-terrestrial access node, wherein the non-terrestrial access node is broadcasting a plurality of tracking area codes (TACs), and wherein a first TAC is associated with a first tracking area (TA) that is forbidden for the UE; and
sending, to a core network node, the plurality of TACs in at least one information element.

41. The method of claim 40, wherein the request message is one of: a registration request message or a service request message.

42. The method of claim 40, the method further comprising:
determining that the UE is located in a second tracking area associated with a second TAC; and
including the second TAC in a first information element and a list of the remaining TACs of the plurality in a second information element.
